(19) United States
(12) Patent Application Publication
(10) Pub. No.: US 2024/0061821 A1
(43) Pub. Date: Feb. 22, 2024

(54) NEAREST NEIGHBOR TRAJECTORY QUERY METHOD AND APPARATUS, ELECTRONIC DEVICE, AND READABLE STORAGE MEDIUM

(71) Applicant: JINGDONG CITY (BEIJING) DIGITS TECHNOLOGY CO., LTD., Beijing (CN)

(72) Inventors: Ruiyuan LI, Beijing (CN); Zisheng YU, Beijing (CN); Jie BAO, Beijing (CN); Yu ZHENG, Beijing (CN)

(73) Assignee: JINGDONG CITY (BEIJING) DIGITS TECHNOLOGY CO., LTD., Beijing (CN)

(21) Appl. No.: 18/259,279

(22) PCT Filed: Sep. 7, 2021
(86) PCT No.: PCT/CN2021/116994

§ 371 Date: Jun. 26, 2023

(30) Foreign Application Priority Data
Dec. 28, 2020 (CN) 202011583540.9

(51) Int. Cl. G06F 16/22; G06F 16/2457

(52) U.S. Cl. CPC G06F 16/2228; G06F 16/24578

(57) ABSTRACT

The present disclosure relates to the technical field of computers, and provides a nearest neighbor trajectory query method and apparatus, an electronic device, and a readable storage medium. The nearest neighbor trajectory query method comprises: acquiring a first trajectory to be queried, and determining spatial position information of the first trajectory; generating a trajectory signature according to a positional relationship between the spatial position information of the first trajectory and a region to be queried; determining a spatial position index code of the first trajectory by means of XZ-Ordering; and constructing a spatial range index of the first trajectory according to the trajectory signature and the spatial position index code.

### CROSS-REFERENCE OF RELATED APPLICATION

The present application is a U.S. National Stage of International Application No. PCT/CN2021/116994, filed on Sep. 7, 2021, which claims benefit of priority to Chinese Application No. 202011583540.9, filed on Dec. 28, 2020, both of which are incorporated herein by reference in their entireties for all purposes.

### TECHNICAL FIELD

The present disclosure relates to the field of computer technologies, and in particular, to a method, apparatus, electronic device, and readable storage medium for querying nearest neighbor trajectory.

### BACKGROUND

K-nearest neighbor trajectory query refers to finding k trajectories that are spatially nearest to a given trajectory based on the Frechet distance.

In the related art, query technology is mainly as follows: taking the query trajectory as the center, continuously expanding the surrounding space, and traversing all the trajectories in the space and sorting by the distance to the query trajectory until the nearest k trajectories are found.

### SUMMARY

Other features and advantages of the present disclosure will become apparent from the ensuing detailed description, or be learned in part by practice of the present disclosure.

According to one aspect of the present disclosure, there is provided a method for querying nearest neighbor trajectory, including: acquiring a first trajectory to be queried, and determining spatial position information of the first trajectory; generating a trajectory signature according to a positional relationship between the spatial position information of the first trajectory and a to-be-queried region; determining a spatial position index code of the first trajectory by XZ-Ordering; constructing a spatial range index of the first trajectory according to the trajectory signature and the spatial position index code.

In some embodiments of the present disclosure, the method further includes: determining an identification of the first trajectory; and adding the identification of the first trajectory to a suffix of the spatial range index.

In some embodiments of the present disclosure, the method further includes: acquiring a random number of the first trajectory; adding the random number to a prefix of the spatial range index; storing the spatial range index randomly to distributed server according to the prefix.

In some embodiments of the present disclosure, the method further includes: taking out an to-be-queried region from the first priority queue storing to-be-queried regions; determining the code length of the spatial position index code of the to-be-queried region; expanding the to-be-queried region or stopping splitting the to-be-queried region according to a size relationship between the code length and the preset length.

In some embodiments of the present disclosure, expanding the to-be-queried region or stopping splitting the to-be-queried region according to a size relationship between the code length and the preset length includes: judging whether the code length is greater than the preset length; if determining that the code length is greater than the preset length, not splitting the to-be-queried region; performing a spatial range query process in the to-be-queried region.

In some embodiments of the present disclosure, expanding the to-be-queried region or stopping splitting the to-be-queried region according to a size relationship between the code length and the preset length includes: judging whether the code length is greater than the preset length; if determining that the code length is less than or equal to the preset length, generating a child node to-be-queried region of the to-be-queried region by performing recursive quadtree splitting on the to-be-queried region, until the code length of the child node to-be-queried region is greater than or equal to the preset length.

In some embodiments of the present disclosure, the method further includes: after stopping the recursive quadtree splitting of the to-be-queried region, determining a second trajectory in the to-be-queried region, and storing the second trajectory in a second priority queue.

In some embodiments of the present disclosure, the method further includes: determining a first Frechet distance between the first trajectory and the to-be-queried region; judging whether the first Frechet distance is greater than or equal to a maximum distance threshold; if determining that the first Fleischer distance is greater than or equal to the maximum distance threshold, performing regional pruning process on the to-be-queried region; and updating the maximum distance threshold according to a result of the regional pruning process.

In some embodiments of the present disclosure, the method further includes: determining a lower bound position of the first trajectory and a lower bound position of the second trajectory in the to-be-queried region; performing a lower bound pruning process on the second trajectory of the to-be-queried region according to the lower bound position of the first trajectory and the lower bound position of the second trajectory, and the lower bound position includes at least one of the lower bound position of the first trajectory, the lower bound position of the second trajectory, and the lower bound position of the trajectory signature.

In some embodiments of the present disclosure, performing a lower bound pruning process on the second trajectory of the to-be-queried region according to the lower bound position of the first trajectory and the lower bound position of the second trajectory includes: determining a Frechet distance of the start points between a lower bound position of a start point of the first trajectory and a lower bound position of an end point of the second trajectory; performing a first lower bound pruning process on the second trajectory according to a size relationship between the Frechet distance of the start points and the first preset distance.

In some embodiments of the present disclosure, performing a lower bound pruning process on the second trajectory of the to-be-queried region according to the lower bound position of the first trajectory and the lower bound position of the second trajectory includes: determining a Frechet distance of end points between a lower bound position of an end point of the first trajectory and a lower bound position of an end point of the second trajectory; performing a second lower bound pruning process on the second trajectory according to a size relationship between the Frechet distance of the end points and a second preset distance.

In some embodiments of the present disclosure, generating a trajectory signature according to a positional relationship between the spatial position information of the first trajectory and a to-be-queried region further includes: performing ordered coding on four child node to-be-queried regions of any of the to-be-queried regions; marking child node to-be-queried region which is passed by the first trajectory with a first identification, and marking child node to-be-queried region which is not passed by the first trajectory with a second identification; and determining the trajectory signature of the first trajectory according to the ordered coding, the first identification and the second identification.

In some embodiments of the present disclosure, performing lower bound pruning process on the second trajectory of the to-be-queried region according to the lower bound position of the first trajectory and the lower bound position of the second trajectory further includes: determining a Frechet distance of trajectory signatures between a lower bound of a trajectory signature of the first trajectory and a lower bound of a trajectory signature of the second trajectory; performing a third lower bound pruning process on the second trajectory according to a size relationship between the Frechet distance of the trajectory signatures and a third preset distance.

According to another aspect of the present disclosure, there is provided a device for querying nearest neighbor trajectory, including: an acquisition module for acquiring a first trajectory to be queried and determining spatial location information of the first trajectory; a signature module for generating a trajectory signature according to a positional relationship between the spatial position information of the first trajectory and to-be-queried region; a determination module for determining a spatial position index code of the first trajectory by XZ-Ordering; an index module for constructing a spatial range index of the first trajectory according to the trajectory signature and the spatial position index code.

According to yet another aspect of the present disclosure, there is provided an electronic device, including: a processor; and a memory for storing executable instructions of the processor; wherein the processor is configured to execute any one of the foregoing methods by executing the executable instructions.

According to yet another aspect of the present disclosure, there is provided a computer-readable storage medium on which a computer program is stored, and when the computer program is executed by a processor, implements any one of the foregoing methods.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the disclosure and together with the description serve to explain the principles of the disclosure. Obviously, the drawings in the following description are only some embodiments of the present disclosure, and for those of ordinary skill in the art, other drawings can also be obtained from these drawings without creative effort.

FIG. 1A shows a schematic coding diagram of a trajectory nearest neighbor query scheme in some embodiments of the present disclosure;

FIG. 1B shows a schematic coding diagram of a nearest neighbor trajectory query scheme in some embodiments of the present disclosure;

FIG. 1C shows a schematic coding diagram of a nearest neighbor trajectory query scheme in some embodiments of the present disclosure;

FIG. 1D shows a schematic coding diagram of a nearest neighbor trajectory query scheme in some embodiments of the present disclosure;

FIG. 2 shows a flowchart of a method for querying nearest neighbor trajectory in some embodiments of the present disclosure;

FIG. 3 shows a flowchart of another method for querying nearest neighbor trajectory in some embodiments of the present disclosure;

FIG. 4 shows a flowchart of another method for querying nearest neighbor trajectory in some embodiments of the present disclosure;

FIG. 5 shows a flowchart of another method for querying nearest neighbor trajectory in some embodiments of the present disclosure;

FIG. 6 shows a flowchart of yet another method for querying nearest neighbor trajectory in some embodiments of the present disclosure;

FIG. 7 shows a flowchart of yet another method for querying nearest neighbor trajectory in some embodiments of the present disclosure;

FIG. 8 shows a flowchart of yet another method for querying nearest neighbor trajectory in some embodiments of the present disclosure;

FIG. 9 shows a flowchart of yet another method for querying nearest neighbor trajectory in some embodiments of the present disclosure;

FIG. 10 shows a flowchart of yet another method for querying nearest neighbor trajectory in some embodiments of the present disclosure;

FIG. 11 shows a flowchart of yet another method for querying nearest neighbor trajectory in some embodiments of the present disclosure;

FIG. 12 shows a flowchart of yet another method for querying nearest neighbor trajectory in some embodiments of the present disclosure;

FIG. 13 shows a flowchart of yet another method for querying nearest neighbor trajectory in some embodiments of the present disclosure;

FIG. 14 shows a schematic diagram of a nearest neighbor trajectory query solution in some embodiments of the present disclosure;

FIG. 15 shows a schematic diagram of yet another nearest neighbor trajectory query solution in some embodiments of the present disclosure;

FIG. 16 is a schematic diagram showing a test result of a nearest neighbor trajectory query scheme in some embodiments of the present disclosure;

FIG. 17 is a schematic diagram showing a test result of a nearest neighbor trajectory query scheme in some embodiments of the present disclosure;

FIG. 18 is a schematic diagram showing a test result of a nearest neighbor trajectory query scheme in some embodiments of the present disclosure;

FIG. 19 is a schematic diagram showing a test result of a nearest neighbor trajectory query scheme in some embodiments of the present disclosure;

FIG. 20 shows a schematic diagram of a device for querying nearest neighbor trajectory in some embodiments of the present disclosure;

FIG. 21 shows a schematic diagram of an electronic device in some embodiments of the present disclosure.

### DETAILED DESCRIPTION

Example embodiments will now be described more fully with reference to the accompanying drawings. Example embodiments, however, can be embodied in various forms and should not be construed as limited to the examples set forth herein; rather, these embodiments are provided so that this disclosure will be thorough and complete, and will fully convey the concept of example embodiments to those skilled in the art. The described features, structures, or characteristics may be combined in any suitable manner in one or more embodiments.

Furthermore, the drawings are merely schematic illustrations of the present disclosure and are not necessarily drawn to scale. The same reference numerals in the drawings denote the same or similar parts, and thus their repeated descriptions will be omitted. Some of the block diagrams shown in the figures are functional entities that do not necessarily correspond to physically or logically separate entities. These functional entities may be implemented in software, or in one or more hardware modules or integrated circuits, or in different networks and/or processor devices and/or microcontroller devices.

However, with the wide application of smart devices and location-based services, large-scale trajectory data has been generated, and traditional methods based on relational databases have been unable to support massive data storage and analysis.

Due to the huge number of trajectory points on the trajectory, the calculation of the Frechet distance is large, which leads to serious efficiency problems in the existing nearest neighbor trajectory query.

The solution provided by the present disclosure improves the efficiency of indexing and querying the to-be-queried region by constructing the spatial range index of the first trajectory, and further improves the efficiency and accuracy of determining trajectories adjacent to the trajectory to be queried in the to-be-queried region. Further, the to-be-queried region is pruned by region pruning, which simplifies the query scope of the second trajectory, improves the efficiency of spatial scope query, and speeds up the query process. Furthermore, by performing lower bound pruning processing on the second trajectory, the calculation amount of the Frechet distance is reduced, and unnecessary trajectory query and query time are reduced. Finally, by randomly storing the spatial range index to the distributed server, the maintenance pressure of the trajectory data is reduced, and the reliability of the nearest neighbor trajectory query is improved.

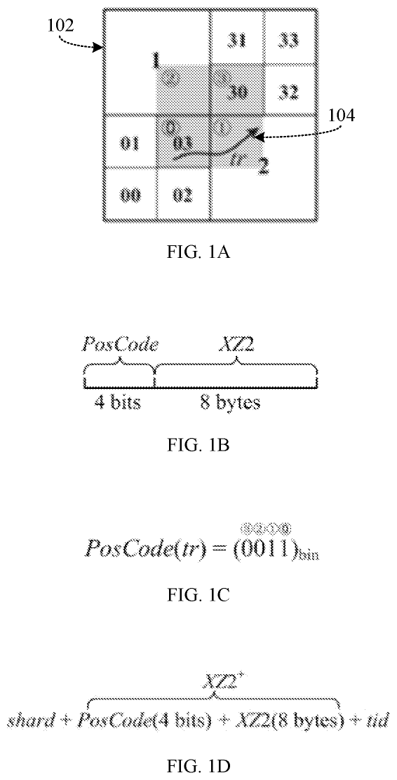

As shown in FIG. 1, the following key concepts are involved in the nearest neighbor trajectory query scheme of the present disclosure:

(1) GPS Point (GPSPoint): The GPS point p=(lat; lng; t) contains a latitude lat, a longitude lng, and a timestamp t. It indicates that the moving object is located at the geographic coordinate position (lat; lng) at time t.

(2) Trajectory (Trajectory): A trajectory tr=<p₁→p₂→ . . . →pₙ> is a sequence formed by sorting the GPS points generated by the same moving object in chronological order, namely: ∀1≤i<n, pᵢ·t<p₁₊₁·t.

(3) Path (Path): Path P=<e₁→e₂→ . . . →eₙ> is a set of a group of continuous road segments, wherein the sequence of the segments is the sequence of object movement. Usually a natural number is used to represent the road segment identification.

(4) Matched trajectory (MapMatchTrajectory): The trajectory can be mapped to the road segment of the road segment after the map matching algorithm, forming the matched trajectory tr=<(e₁, t₁)→(e₂, t₂)→ . . . →(eₖ, tₖ)>. Among them, eᵢ refers to the identification of the road segment on the road network, and tᵢ refers to the time when the moving object enters the road segment. In the following, unless otherwise specified, the trajectories mentioned are all matched trajectories.

(5) Nearest neighbor trajectory query (PathTemporalRangeQuery): Given a path P, a time range [tₛ, tₑ] and a set of matching trajectories T, the nearest neighbor trajectory query finds all matching trajectories trᵢ in T, and there is a certain sub-trajectory tr′ᵢ=<(e₁, t₁)→(e₂, t₂)→ . . . →(eₖ, tₖ)> happens to pass through the path P within the given time period, i.e., t₁≥tₛ, tₖ≤tₑ.

(6) NoSQL: It refers to a non-relational database in general, and its data storage does not require a fixed table schema. It was created to solve the challenges brought by multiple data types in big data collections, especially big data application problems.

(7) HBase: A highly reliable, high-performance, column-oriented and scalable distributed storage system that can build large-scale structured storage clusters on inexpensive machines, and is a type of NoSQL.

(8) Frechet Distance: Frechet Distance, a description of path space similarity, is often used to measure the similarity between trajectories.

(9) XZ-Ordering: An encoding method for space-filling curves combined with temporal information.

(10) Priority queue: a common data structure, its elements are given priority, and the element with the highest priority is deleted first, so compared with the first-in, first-out of the ordinary queue, the priority queue has the characteristics of the highest level, first out.

The solutions provided by the embodiments of the present disclosure involve technologies such as suffix tree, path decomposition, and distributed architecture, and are specifically described by the following embodiments.

The above nearest neighbor trajectory query scheme can be implemented through the interaction of multiple terminals and server clusters.

The terminal can be a mobile terminal such as a mobile phone, a game console, a tablet computer, an e-book reader, smart glasses, an MP4 (Moving Picture Experts Group Audio Layer IV, moving picture expert compression standard audio layer 4) player, a smart home device, AR (Augmented Reality) device and a VR (Virtual Reality) device, or the terminal may also be a personal computer (PC), such as a laptop portable computer, a desktop computer, and the like.

An application program for providing nearest neighbor trajectory query may be installed in the terminal.

The terminal and the server cluster are connected through a communication network. In some embodiments, the communication network is a wired network or a wireless network.

A server cluster is a server, or consists of several servers, or a virtualization platform, or a cloud computing service center. The server cluster is used to provide background service for an application that provides nearest neighbor trajectory query. Optionally, the server cluster undertakes the main computing work, and the terminal undertakes the secondary computing work; or, the server cluster undertakes the secondary computing work, and the terminal undertakes the main computing work; or, a distributed computing architecture is used between the terminal and the server cluster for collaborative computing.

In some optional embodiments, the suffix tree index is initially used to index strings, which can improve the performance of string suffix search. In trajectory data management, the matched trajectory can be regarded as a string, the identification of each road segment is equivalent to a character of the string, and the path query (regardless of the time filter condition) can be mapped to the suffix search problem of the string, that is, the search using the road segment identification sequence can be regarded as the search using the character sequence.

Optionally, the clients of the application programs installed in different terminals are the same, or the clients of the application programs installed on the two terminals are clients of the same type of application programs of different control system platforms. Based on different terminal platforms, the specific form of the client of the application program may also be different, for example, the client of the application program may be a mobile phone client, a PC client, or a global wide area network client.

Those skilled in the art may know that the number of the above-mentioned terminals may be more or less. For example, the above-mentioned terminal may be only one, or the above-mentioned terminal may be dozens or hundreds, or more. The embodiments of the present disclosure do not limit the number of terminals and device types.

Optionally, the system may further include a management device, and the management device and the server cluster are connected through a communication network. Optionally, the communication network is a wired network or a wireless network.

Optionally, the above-mentioned wireless network or wired network uses standard communication technologies and/or protocols. The network is usually the Internet, but can also be any network, including but not limited to Local Area Network (LAN), Metropolitan Area Network (MAN), Wide Area Network (W logo e Area Network, WAN), mobile, wired or any combination of wireless, private, or virtual private networks). In some embodiments, data exchanged over a network is represented using technologies and/or formats including Hyper Text Mark-up Language (HTML), Extensible Markup Language (XML), and the like. In addition, conventional encryption techniques such as Secure Socket Layer (SSL), Transport Layer Security (TLS), Virtual Private Network (VPN), Internet Protocol Security (IPsec), etc can be used to encrypt all or some of the links. In other embodiments, custom and/or dedicated data communication techniques may also be used in place of or in addition to the data communication techniques described above.

Hereinafter, each step of the method for querying nearest neighbor trajectory in this exemplary implementation will be described in more detail with reference to the accompanying drawings and embodiments.

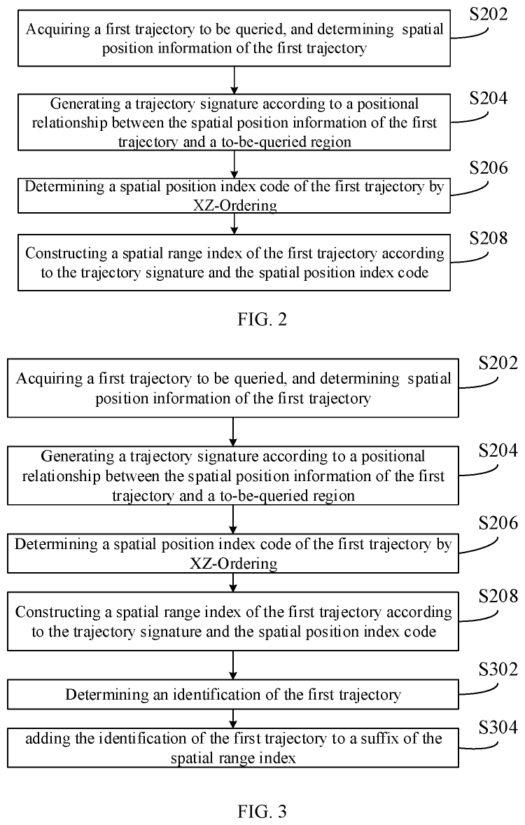

FIG. 2 shows a flowchart of a method for querying nearest neighbor trajectory in some embodiments of the present disclosure. The methods provided by the embodiments of the present disclosure can be executed by any electronic device with computing processing capability, and a server cluster is used as an executing entity for illustration.

As shown in FIG. 2, the server cluster executes the nearest neighbor trajectory query method, including the following steps:

Step S202: acquiring a first trajectory to be queried, and determining the spatial position information of the first trajectory.

Step S204: generating a trajectory signature according to a positional relationship between the spatial position information of the first trajectory and a to-be-queried region.

In the above embodiment, the to-be-queried region 102 is divided into β×β areas of the same size, where R is an integer greater than or equal to 1, and each area is coded from 0, that is, the spatial position information of the trajectory (tr) 104 can be represented by a β×β binary sequence.

For example, if at least one GPS point in the trajectory (tr) 104 falls in a certain area, its corresponding binary position is set to 1, otherwise it is set to 0. As shown in FIG. 1A and FIG. 1C, PosCode (tr)=0011.

Step S206, determining a spatial position index code of the first trajectory through XZ-Ordering.

In the above embodiment, the spatial position index code is a code generated based on XZ-Ordering. First, a quaternary sequence of a trajectory is obtained, and then the quaternary sequence is converted into a decimal long integer number.

Step S208, constructing a spatial range index of the first trajectory according to the trajectory signature and the spatial position index code.

In the above embodiment, by constructing the spatial range index of the first trajectory, the efficiency of indexing and querying the to-be-queried region is improved, thereby improving the efficiency and accuracy of determining the trajectory adjacent to the trajectory to be queried in the to-be-queried region. Further, the to-be-queried region is pruned by region pruning, which simplifies the query range of the second trajectory, improves the efficiency of spatial range query, and speeds up the query process. Furthermore, by performing lower bound pruning on the second trajectory, the calculation amount of the Frechet distance is reduced, and unnecessary trajectory query and query time are reduced.

Based on the steps shown in FIG. 2, as shown in FIG. 3, the method for querying nearest neighbor trajectory further includes:

Step S302, determining an identification of the first trajectory.

Step S304, adding the identification of the first trajectory to the suffix of the spatial range index.

In the above embodiment, by adding the identification of the first trajectory to the suffix of the spatial range index, spatial range query is supported, that is, given a query space, all trajectory records in the space can be queried.

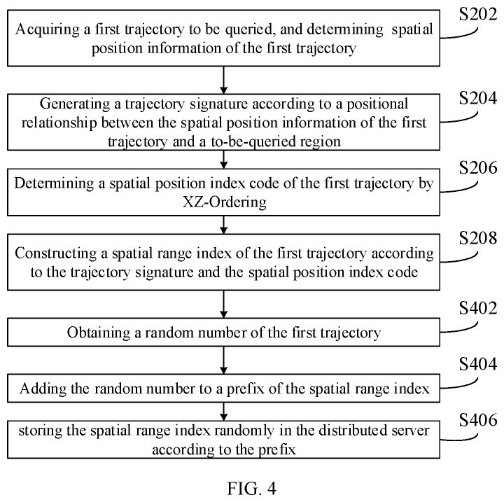

Based on the steps shown in FIG. 2, as shown in FIG. 4, the method for querying nearest neighbor trajectory further includes:

Step S402, obtaining a random number of the first trajectory.

Step S404, adding the random number to a prefix of the spatial range index.

Step S406: storing the spatial range index randomly in the distributed server according to the prefix.

In the above embodiment, by randomly storing the spatial range index to the distributed server, the data can be effectively distributed to different data servers, which increases the pressure on load balancing and data hotspots, reduces maintenance pressure on a large amount of trajectory data, and improves the reliability of nearest neighbor trajectory query.

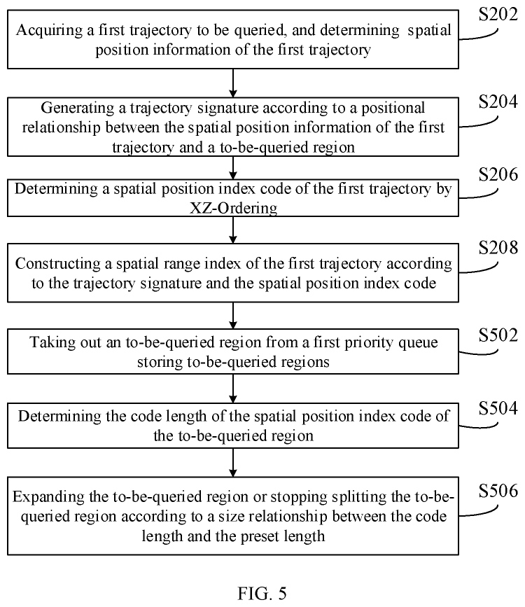

Based on the steps shown in FIG. 2, as shown in FIG. 5, the method for querying the neighbors of the trajectory further includes:

Step S502, taking out an to-be-queried region from a first priority queue storing to-be-queried regions.

Step S504, determining the code length of the spatial position index code of the to-be-queried region.

Step S506, expanding the to-be-queried region or stopping splitting the to-be-queried region according to a size relationship between the code length and the preset length.

In the above embodiment, since the larger the code length of the spatial position index code of the to-be-queried region, the more accurate the spatial representation of the trajectory is, the precision of the to-be-queried region is controlled by the preset length.

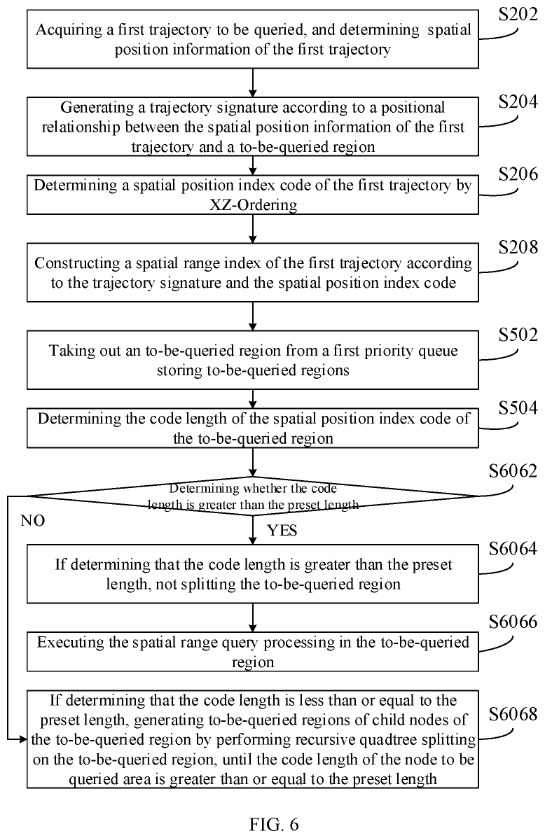

Based on the steps shown in FIG. 2 and FIG. 5, as shown in FIG. 6, said according to the size relationship between the code length and the preset length, expanding the to-be-queried region or stopping splitting the to-be-queried region includes:

Step S6062, determining whether the code length is greater than the preset length. If yes, the method goes to step S6064, and if no, the method goes to step S6068.

Step S6064, if determining that the code length is greater than the preset length, not splitting the to-be-queried region.

Step S6066, executing the spatial range query processing in the to-be-queried region.

In the above embodiment, if it is determined that the code length is greater than the preset length, the to-be-queried region is not split, and the spatial range query processing is performed in the to-be-queried region. On the premise of ensuring the query accuracy, the query scope of the second trajectory is effectively reduced.

Based on the steps shown in FIG. 2 and FIG. 5, as shown in FIG. 6, said according to the size relationship between the code length and the preset length, expanding the to-be-queried region or stopping splitting the to-be-queried region also includes:

Step S6062, judging whether the code length is greater than the preset length.

Step S6068, if determining that the code length is less than or equal to the preset length, generating to-be-queried regions of child nodes of the to-be-queried region by performing recursive quadtree splitting on the to-be-queried region, until the code length of the node to be queried area is greater than or equal to the preset length.

In the above embodiment, if it is determined that the code length is less than or equal to the preset length, by performing recursive quadtree splitting on the to-be-queried region, until the code length of to-be-queried region of the child node is greater than or equal to the preset length, the splitting process of the to-be-queried region is accurately controlled.

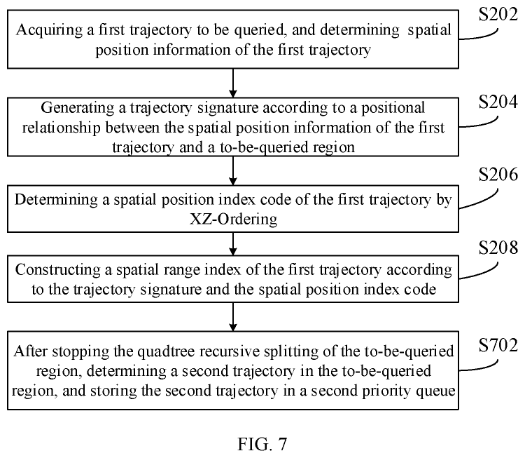

Based on the steps shown in FIG. 2, as shown in FIG. 7, the method for querying nearest neighbor trajectory further includes:

Step S702, after stopping the quadtree recursive splitting of the to-be-queried region, determining a second trajectory in the to-be-queried region, and storing the second trajectory in a second priority queue.

In the above embodiment, after the quadtree recursive splitting of the to-be-queried region is stopped, the second trajectories in the to-be-queried region are determined, and the second trajectories are stored in the second priority queue. The number of second trajectories in the second priority queue satisfies the requirement of the number of queries.

In addition, the second trajectory in the second priority queue also has priority, and the element with the highest priority is deleted first, that is, in the subsequent lower bound pruning process, it is prioritized for pruning process to obtain a second trajectory that meets the query distance requirement faster.

Specifically, if the length of the coding sequence of the to-be-queried region is less than a constant g given by the system, the child nodes of the four quadtrees of the to-be-queried region are added to the first priority queue, and then the next area in the first priority queue is checked. If the length of the coding sequence of the to-be-queried region reaches a given constant g, the to-be-queried region is no longer split, and the to-be-queried region is directly used to perform a spatial range query to obtain the trajectory result set T_{SR}.

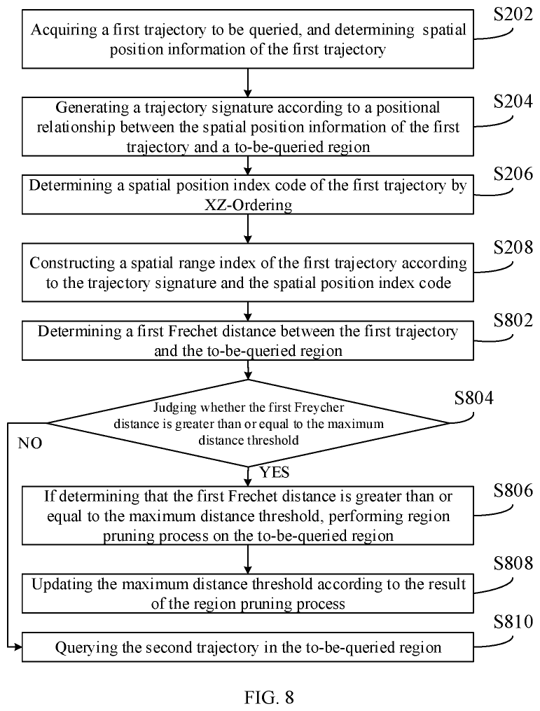

Based on the steps shown in FIG. 2, as shown in FIG. 8, the method for querying the neighbors of the trajectory further includes:

Step S802, determining a first Frechet distance between the first trajectory and the to-be-queried region.

Step S804, judging whether the first Freycher distance is greater than or equal to the maximum distance threshold. If so, the method goes to step S806, and if not, the method goes to step S810.

Step S806, if determining that the first Frechet distance is greater than or equal to the maximum distance threshold, performing region pruning process on the to-be-queried region.

Step S808, updating the maximum distance threshold according to the result of the region pruning process.

Step S810, querying the second trajectory in the to-be-queried region.

In the above-mentioned embodiment, the inventor has determined through verification and reasoning that if Region_LB_{f}_{_{F}}(q, r)>dₘₐₓ, then f_{F}(q, tr)>dₘₐₓ holds, and f_{F}(q, tr) is the Frechet distance between the trajectory and the to-be-queried space, where the trajectory tr is trajectory retrieved for the first time when the spatial range query is performed in the to-be-queried space.

Specifically, if the second trajectory is not retrieved for the first time, that is, retrieved by a previous “inner” query area, then it must be checked to see if it exists in the result set of the k-nearest neighbor trajectory query.

In addition, if the second trajectory is retrieved for the first time, then there are:

$${f}_{F} ( q , tr ) \geq max \{ \begin{matrix}max \\ {q}_{i} ∈ q\end{matrix} \begin{matrix}min \\ {p}_{j} ∈ t r\end{matrix} d ( {q}_{i} , {p}_{j} ) , \begin{matrix}max \\ {p}_{j} ∈ tr\end{matrix} \begin{matrix}min \\ {q}_{i} ∈ q\end{matrix} d ( {q}_{i} , {p}_{j} ) \} \geq max \{ \begin{matrix}max \\ {q}_{i} ∈ q\end{matrix} \begin{matrix}min \\ {p}_{j} ∈ tr . mbr\end{matrix} d ( {q}_{i} , {p}_{j} ) , \begin{matrix}max \\ {p}_{j} ∈ tr . mbr\end{matrix} \begin{matrix}min \\ {q}_{i} ∈ q\end{matrix} d ( {q}_{i} , {p}_{j} ) \} \geq max \{ \begin{matrix}max \\ {q}_{i} ∈ q\end{matrix} \begin{matrix}min \\ {p}_{j} ∈ r\end{matrix} d ( {q}_{i} , {p}_{j} ) , \begin{matrix}max \\ {p}_{j} ∈ r\end{matrix} \begin{matrix}min \\ {q}_{i} ∈ q\end{matrix} d ( {q}_{i} , {p}_{j} ) \} > \begin{matrix}max \\ {q}_{i} ∈ q\end{matrix} \begin{matrix}min \\ {p}_{j} ∈ r\end{matrix} d ( {q}_{i} , {p}_{j} ) = \begin{matrix}max \\ {q}_{i} ∈ q\end{matrix} d ( {q}_{i} , r ) = Region\_LB ( q , r ) > {d}_{max}$$

established.

Based on this, pruning the to-be-queried region by the first Frecher distance can effectively remove the invalid area of the to-be-queried region, thereby improving the efficiency and reliability of the nearest neighbor trajectory query.

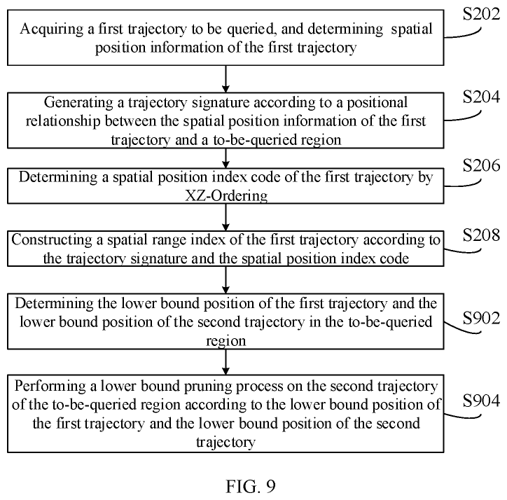

Based on the steps shown in FIG. 2, as shown in FIG. 9, the method for querying the neighbors of the trajectory further includes:

Step S902: determining the lower bound position of the first trajectory and the lower bound position of the second trajectory in the to-be-queried region.

Step S904, performing a lower bound pruning process on the second trajectory of the to-be-queried region according to the lower bound position of the first trajectory and the lower bound position of the second trajectory, where the lower bound position includes at least one of the starting lower bound position and the ending lower bound position and the lower bound position of the trajectory signature.

In the above-mentioned embodiment, the pruning process is performed by the Frechet distance between the lower bound position of the first trajectory and the lower bound position of the second trajectory, so as to avoid the amount of computation of performing distance calculation on all the trajectory points of the first trajectory and the second trajectory, and reduce the time complexity.

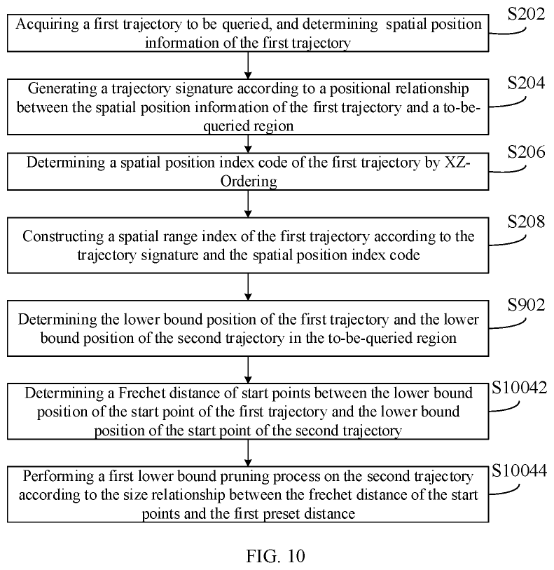

Based on the steps shown in FIG. 2, as shown in FIG. 10, according to the lower bound position of the first trajectory and the lower bound position of the second trajectory, performing lower bound pruning process on the second trajectory of the to-be-queried region includes:

Step S10042, determining a Frechet distance of start points between the lower bound position of the start point of the first trajectory and the lower bound position of the start point of the second trajectory.

Step S10044, performing a first lower bound pruning process on the second trajectory according to the size relationship between the frechet distance of the start points and the first preset distance.

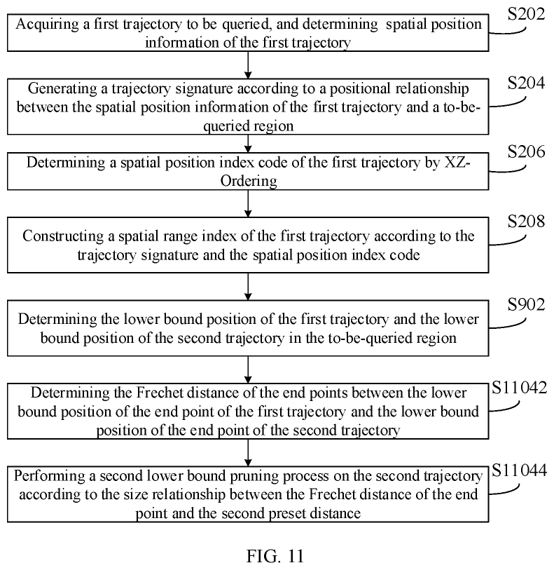

Based on the steps shown in FIGS. 2 and 9, as shown in FIG. 11, lower bound pruning process is performed on the second trajectory of the to-be-queried region according to the lower bound position of the first trajectory and the lower bound position of the second trajectory further includes:

Step S11042: determining the Frechet distance of the end points between the lower bound position of the end point of the first trajectory and the lower bound position of the end point of the second trajectory.

Step S11044: performing a second lower bound pruning process on the second trajectory according to the size relationship between the Frechet distance of the end point and the second preset distance.

In the above-mentioned embodiment, based on the start and end points of the trajectory, the present disclosure proposes the lower bound of the distance between the start and end points of similar trajectories (Lower Bound, the return value of lower_bound( ) is an iterator, which returns a location of a value that points to the first value greater than or equal to the key). If the lower bound of the distance is greater than the given similarity threshold E, then the first trajectory and the second trajectory must not be similar. Based on this, fast pruning is performed on the second trajectory of the to-be-queried region.

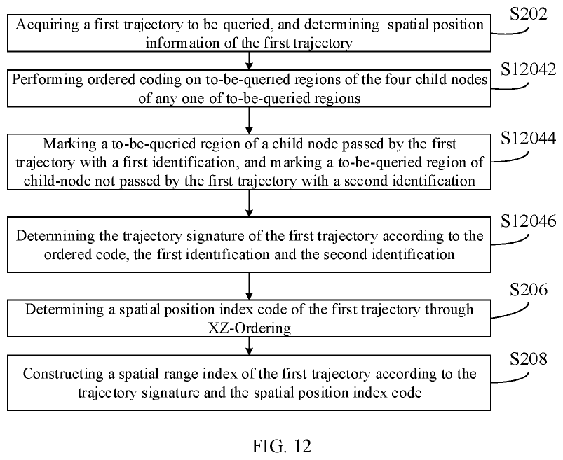

Based on the steps shown in FIG. 2, as shown in FIG. 12, generating a trajectory signature according to the positional relationship between the spatial position information of the first trajectory and an to-be-queried region further includes:

Step S12042, performing ordered coding on to-be-queried regions of the four child nodes of any one of to-be-queried regions.

Step S12044, marking a to-be-queried region of a child node passed by the first trajectory with a first identification, and marking a to-be-queried region of child-node not passed by the first trajectory with a second identification.

Step S12046: determining the trajectory signature of the first trajectory according to the ordered code, the first identification and the second identification.

In the above embodiment, the first identification may be a binary “1”, and the second identification may be a binary “0”, and a unique trajectory signature is generated according to the sequence of the ordered code.

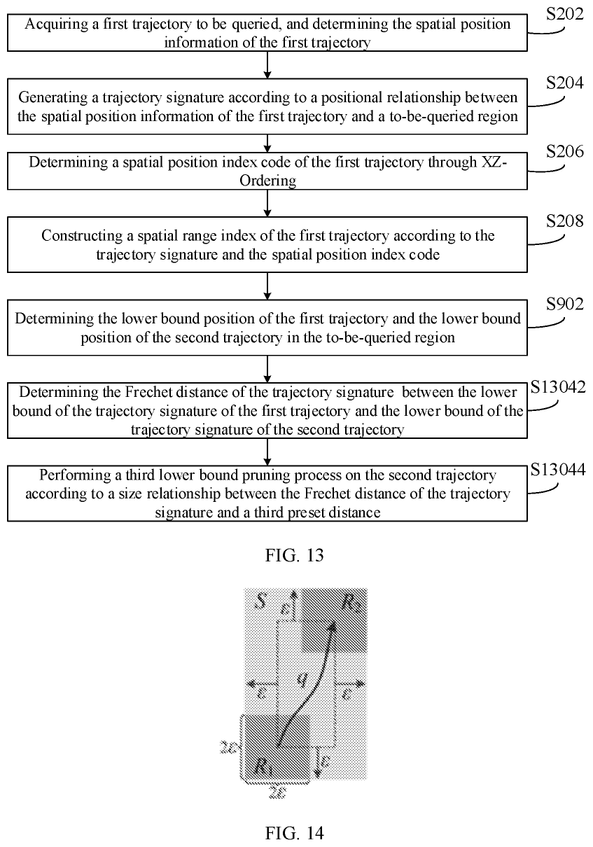

Based on the steps shown in FIG. 2 and FIG. 9, as shown in FIG. 13, lower bound pruning process is performed on the second trajectory of the to-be-queried region according to the lower bound position of the first trajectory and the lower bound position of the second trajectory further includes:

Step S13042: determining the Frechet distance of the trajectory signature between the lower bound of the trajectory signature of the first trajectory and the lower bound of the trajectory signature of the second trajectory.

Step S13044, performing a third lower bound pruning process on the second trajectory according to a size relationship between the Frechet distance of the trajectory signature and a third preset distance.

In the above-mentioned embodiment, the inventor determines through verification and reasoning that if SIG_LB_{f}_{_{F}}(q, tr)>ε, then f_{F}(tr, q)>ε.

Proof: For any point qᵢ∈q [symbol] pⱼ∈tr, they must fall in a signature area r_{q}ⁱ and rₜᵣ^{j} in the to-be-queried area q and trajectory tr, respectively.

Therefore, it can be proved that:

$${f}_{F} ( tr , q ) \geq max \{ \begin{matrix}max \\ {q}_{i} ∈ q\end{matrix} \begin{matrix}min \\ {p}_{j} ∈ t r\end{matrix} d ( {q}_{i} , {p}_{j} ) , \begin{matrix}max \\ {p}_{j} ∈ tr\end{matrix} \begin{matrix}min \\ {q}_{i} ∈ q\end{matrix} d ( {p}_{j} , {q}_{i} ) \} \geq max \{ \begin{matrix}max \\ {q}_{i} ∈ q\end{matrix} \begin{matrix}min \\ {r}_{tr} ∈ Sig ( tr )\end{matrix} d ( {q}_{i} , {r}_{tr} ) ,$$

$$\begin{matrix}max \\ {p}_{j} ∈ tr\end{matrix} \begin{matrix}min \\ {r}_{q} ∈ Sig ( q )\end{matrix} d ( {p}_{j} , {r}_{q} ) \} \geq max \{ \begin{matrix}max \\ {r}_{q} ∈ Sig ( q )\end{matrix} \begin{matrix}min \\ {r}_{tr} ∈ Sig ( tr )\end{matrix} d ( {r}_{q} , {r}_{tr} ) ,$$

$$\begin{matrix}max \\ {r}_{tr} ∈ Sig ( tr )\end{matrix} \begin{matrix}min \\ {r}_{q} ∈ Sig ( q )\end{matrix} d ( {r}_{tr} , {r}_{q} ) \} = {SIG\_LB}_{{f}_{F}} ( q , tr ) > ε .$$

Among them, the computational time complexity of SIG_LB is O(α2), and α<<|q|, α<<|tr|, can be regarded as a constant, so the filtering effect can still be greatly accelerated.

Based on this, the trajectory signature can more accurately indicate the position information of the trajectory. Therefore, the present disclosure proposes a means of lower bound of the signature. If the lower bounds of the signatures of the two trajectories are greater than a given threshold ε, then the first trajectory and the second trajectory are definitely not similar, and more efficient fast pruning is performed on the second trajectory of the to-be-queried region.

FIG. 14 to FIG. 19 illustrate one embodiment of a nearest-neighbor trajectory query scheme, where the present disclosure treats the spatial range query as a sub-operation in the k-nearest neighbor trajectory query.

As shown in FIG. 14, given a query trajectory q, a distance threshold F (assuming that the present disclosure has converted its unit from length to spatial coordinate degree), two spatial regions R₁={lat₁−ε, lng₁−ε, lat₁+ε, lng₁+ε} and R₂={latₙ−ε, lngₙ−ε, latₙ+ε, lngₙ+ε} can be obtained, where GPS points (lat₁, lng₁) and (latₙ, lngₙ) are respectively start and end points of the query trajectory q. For the Frechet distance f_{F}, all trajectories similar to q must be included in the result of the spatial range query T′=SR_query(T; R₁)∩SR_query(T; R₂).

MBR (Minimum Bounding Rectangle) pruning: given a query trajectory q, a similarity threshold ε, where q·mbr={latₘᵢₙ, lngₘᵢₙ, latₘₐₓ, lngₘₐₓ}. The present disclosure can obtain a spatial range S={latₘᵢₙ−ε, lngₘᵢₙ−ε, latₘₐₓ+ε, lngₘₐₓ+ε}, and the MBR of all trajectories similar to q must be completely contained in S.

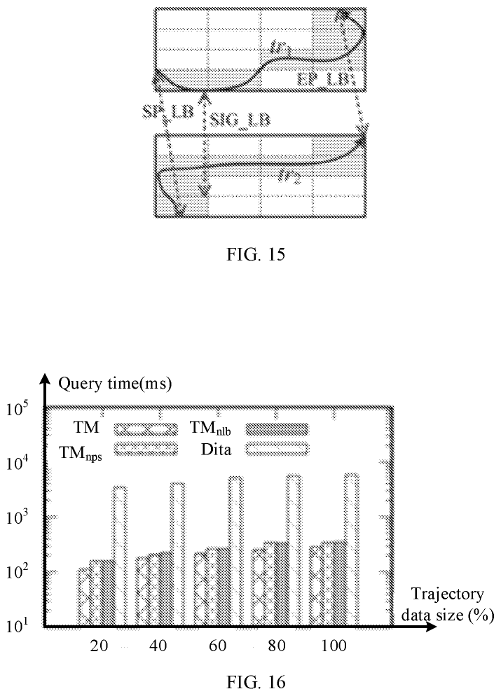

With reference to FIG. 15, the inventor proposed lower bound pruning and trajectory signature pruning with respect to the similarity between the first trajectory tr₁ and the second trajectory tr₂, and proposed and verified the following theorems to improve the reliability and efficiency of nearest neighbor trajectory query.

Theorem 1. Similar Trajectory Query Integrity Theorem: For the Frechet distance f_{F}, all trajectories that are similar in shape to a given query trajectory are in the set T′.

Theorem 2. Region Pruning Theorem: If Region_LB_{f}_{_{F}}(q, r)>dₘₐₓ, then f_{F}(q, tr)>dₘₐₓ, where the trajectory tr is a trajectory retrieved for the first time by r in the spatial range query.

Theorem 3. MBR pruning theorem: If the trajectory tr is not completely contained in the region S, that is: there is at least one GPS point p in tr that falls outside the region S, then for the Frechet distance, tr must not be similar to q.

Theorem 4. Lower bound pruning theorem for start and end points: If SP_LB_{f}_{_{F}}(q, tr)>ε, then f_{F}(tr, q)>ε. If EP_LB_{f}_{_{F}}(q, tr)>ε, then f_{F}(tr, q)>ε.

Theorem 5. Signature Lower Bound Pruning Theorem: If SIG_LB_{f}_{_{F}}(q, tr)>ε, then f_{F} (tr, q)>ε.

According to the embodiment of the present disclosure, by inputting the query point q, the Frechet distance function f_{F}, and the number k of trajectories to be returned, the output is the k-nearest neighbor query trajectory result set Tₖₙₙ, which can be specifically divided into the following three stages:
The first stage of query: mainly initializing some variables, among which, cdq is a second priority queue for storing the second trajectory, req identifies a first priority queue, and records the range of the space area to be checked, dₘₐₓ is the maximum value of distances between the current query trajectory q and all trajectories within cdq.

The second stage of the query: taking a spatial region r from req. If there are already k trajectories in the candidate set cdq, and the distance between the spatial region r and the query trajectory q is greater than dₘₐₓ, it means that those unretrieved trajectories will definitely not be in the result set (see Theorem 2, which this disclosure calls it region pruning), and the query process can be ended.

If the length of the coding sequence of r is less than a constant g given by the system, in the present disclosure, the child nodes of the four quadtrees of r are added to req, and then the next region in req is checked.

If the length of the coding sequence of r reaches a given constant g, in the present disclosure, r is not split any more, but a spatial range query is performed by directly using r to obtain a result set T_{SR}.

For each trajectory tr∈T_{SR}, the present disclosure proposes two lower bound pruning strategies due to the excessive time overhead of similarity between trajectories.

If tr satisfies all of the above lower bounds, in the present disclosure, it is added to the candidate result set cdq, and then dₘₐₓ is updated.

The third stage of query: when all the candidate regions of req have been checked, in the present disclosure, the trajectory in the candidate result cdq is the final result and is returned.

FIG. 16 to FIG. 19 show the performance test results and query performance results of the nearest neighbor trajectory query of the present disclosure.

(1) Performance Test Results

This disclosure uses two datasets to verify the performance of the method proposed in this disclosure: 1) T-Drive [1], which is a public dataset containing GPS point information of more than 10,000 taxis in Beijing, with a time span of 7 days from Feb. 2, 2008 to Feb. 8, 2008; 2) Lorry, this is a truck GPS trajectory data set, which contains the GPS trajectory information of nearly 50,000 Jingdong logistics trucks in Guangzhou for one month, and the time span is from Mar. 1, 2014 to Mar. 31, 2014. This disclosure uses Spark to preprocess the to-be-processed trajectories, with HBase as the underlying NoSQL storage. All experiments are performed in a cluster with 5 nodes, each node is installed with Centos7.4 operating system, with 8-core CPU, 32 GB memory and 1T ordinary mechanical disk.

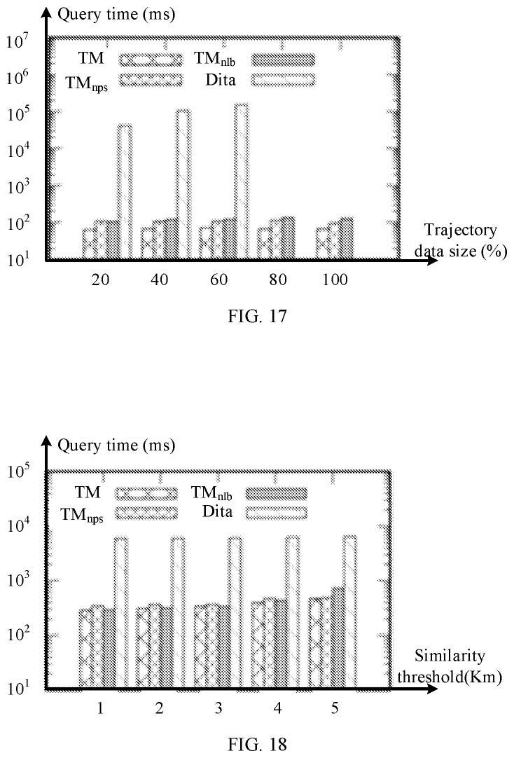

As shown in FIG. 16 and FIG. 17, the method proposed in this disclosure is TM, and three kinds of comparative experiments are proposed: 1) Dita, which is a representative memory-based trajectory management system, which proposes an efficient data partition method, and solves the problem of data locality, and also proposes a cost-based technology to achieve load balancing; its main idea is to identify representative GPS points, and then design a tree-structured index based on these representative points, which can efficiently filter out those dissimilar trajectories; 2) TMₙₚₛ, which is a variant of TM method, does not use PosCode technology in the spatial range index table; 3) TM_{nib}, which is another variant of TM method, does not use a lower bound pruning strategy in the process of similar query.

When considering the trajectory similarity metric, the present disclosure adopts the Frechet distance f_{F}, and the experimental results of other distance metric functions such as the Hausdorff distance f_{H} and dynamic time warping f_{D} are similar.

(2) Query Performance Comparison.

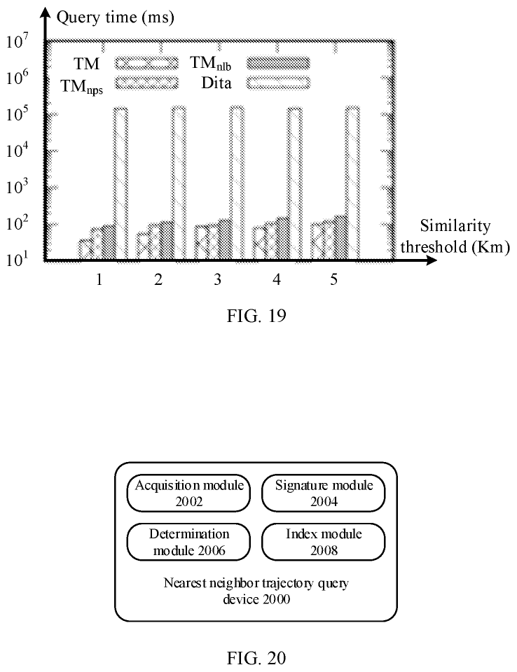

As shown in FIG. 18 and FIG. 19, the changes of time for similarity query under different amount of data are compared. The similarity threshold defaults to 3 km.

For all methods, as the amount of data increases, the time required for similarity query increases, because the larger the amount of data, the more trajectories are returned under the same similarity threshold. TM is slightly faster than TMₙₚₛ, because the underlying call for similar query is a spatial range query, in which PosCode can reduce unnecessary trajectory scanning and improve query efficiency.

If the lower bound pruning filtering algorithm is not used, the present disclosure needs to call the Frecher distance calculation formula to verify all trajectories that satisfy the spatial range query, which is very time-consuming, so TM_{nib} is slower than TM. Dita is much slower than TM. As mentioned earlier, Dita builds a large index in memory. For each query, Dita scans the index file, which takes a lot of time.

The TM can directly generate the query window, and then convert it into a parallel SCAN operation at the bottom layer. Due to the need for more memory overhead, Dita has relatively high requirements on the cluster, and its scalability is limited.

In fact, when the Lorry (load) dataset is greater than 60%, Dita throws a memory overflow exception, but the TM is still able to run very well, even if the Lorry dataset reaches 100%, the TM still works smoothly, which reflects powerful scalability of the TM method.

As shown in FIG. 18 and FIG. 19, as the similarity threshold E increases, the time overhead of similarity queries also increases slightly for all methods, since this returns more trajectories that satisfy the condition. TM and its variant methods are much faster than Dita, sometimes even reach efficiency improvement of 3 orders of magnitude, which further demonstrates the efficiency of the present disclosure.

The nearest neighbor trajectory query apparatus 2000 according to this embodiment of the present disclosure will be described below with reference to FIG. 20. The nearest neighbor trajectory query apparatus 2000 shown in FIG. 20 is only an example, and should not impose any limitations on the functions and scope of use of the embodiments of the present disclosure.

The nearest neighbor trajectory query device 2000 is represented in the form of a hardware module. The components of the nearest neighbor trajectory query apparatus 2000 may include, but are not limited to: an acquisition module 2002, a signature module 2004, a determination module 2006 and an index module 2008.

The acquisition module 2002 is configured to acquire the first trajectory to be queried, and determine the spatial position information of the first trajectory.

The signature module 2004 is configured to generate a trajectory signature according to the positional relationship between the spatial position information of the first trajectory and the to-be-queried region.

The determination module 2006 is configured to determine the spatial position index code of the first trajectory through XZ-Ordering.

The index module 2008 is configured to construct a spatial range index of the first trajectory according to the trajectory signature and the spatial position index code.

The present disclosure proposes a nearest neighbor trajectory query scheme. By constructing a spatial range index of the first trajectory, the indexing and query efficiency of the to-be-queried region are improved, and the efficiency and accuracy of determining trajectories adjacent to the trajectory to be queried in the to-be-queried region is improved. Further, the to-be-queried region is pruned by region pruning, which simplifies the query range of the second trajectory, improves the efficiency of spatial range query, and speeds up the query process. Furthermore, by performing lower bound pruning processing on the second trajectory, the calculation amount of the Frechet distance is reduced, and unnecessary trajectory query and query time are reduced. Finally, by randomly storing the spatial range index to the distributed server, the maintenance pressure of the trajectory data is reduced, and the reliability of the nearest neighbor trajectory query is improved.

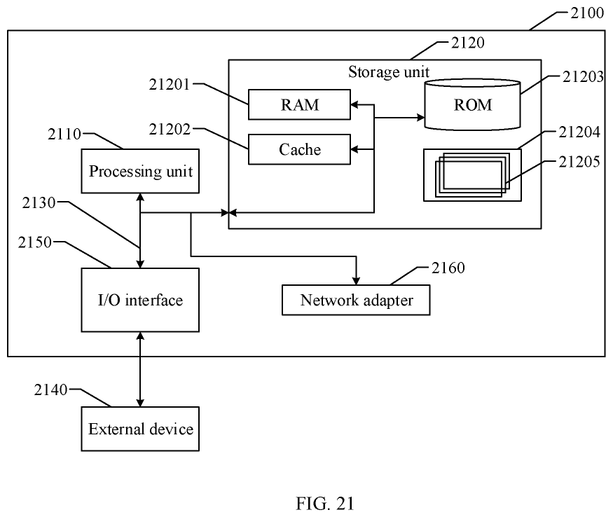

An electronic device 2100 according to this embodiment of the present disclosure is described below with reference to FIG. 21. The electronic device 2100 shown in FIG. 21 is only an example, and should not impose any limitation on the functions and scope of use of the embodiments of the present disclosure.

As shown in FIG. 21, electronic device 2100 takes the form of a general-purpose computing device. Components of the electronic device 2100 may include, but are not limited to, the above-mentioned at least one processing unit 2110, the above-mentioned at least one storage unit 2120, and a bus 2130 connecting different system components (including the storage unit 2120 and the processing unit 2110).

The storage unit stores program codes, which can be executed by the processing unit 2110, so that the processing unit 2110 performs the steps according to various exemplary embodiments of the present disclosure described in the above-mentioned “Exemplary Methods” section of this specification. For example, the processing unit 2110 may perform the steps of the nearest neighbor trajectory query method as shown in FIGS. 2 to 13, and other steps defined in the nearest neighbor trajectory query method of other embodiments of the present disclosure.

The storage unit 2120 may include a readable medium in the form of a volatile storage unit, such as a random access storage unit (RAM) 21201 and/or a cache storage unit 21202, and may further include a read only storage unit (ROM) 21203.

The storage unit 2120 may also include a program/utility 21204 having a set (at least one) of program modules 21205 including, but not limited to, an operating system, one or more application programs, other program modules, and program data, and an implementation of a network environment may be included in each or some combination of these examples.

The bus 2130 may represent one or more of several types of bus structures, including a memory cell bus or memory cell controller, a peripheral bus, a graphics acceleration port, a processing unit, or a local area using any of a variety of bus structures bus.

The electronic device 2100 may also communicate with one or more external devices 2140 (e.g., keyboards, pointing devices, Bluetooth devices, etc.), may also communicate with one or more devices that enable a user to interact with the electronic device, and/or communicate with any device (e.g., router, modem, etc.) that enable the electronic device 2100 communicate with one or more other computing devices. Such communication may take place through input/output (I/O) interface 2150. Also, the electronic device 2100 may communicate with one or more networks (e.g., a local area network (LAN), a wide area network (WAN), and/or a public network such as the Internet) through a network adapter 2160. The network adapter 2160 communicates with other modules of the electronic device 2100 through the bus 2130. It should be understood that, although not shown in the figures, other hardware and/or software modules may be used in conjunction with the electronic device, including but not limited to: microcode, device drivers, redundant processing units, external disk drive arrays, RA identification systems, tape drives and data backup storage systems.

From the description of the above embodiments, those skilled in the art can easily understand that the exemplary embodiments described herein may be implemented by software, or may be implemented by software combined with necessary hardware. Therefore, the technical solutions according to the embodiments of the present disclosure may be embodied in the form of software products, and the software products may be stored in a non-volatile storage medium (which may be CD-ROM, U disk, mobile hard disk, etc.) or on the network, including several instructions to cause a computing device (which may be a personal computer, a server, a terminal device, or a network device, etc.) to execute the method according to some embodiments of the present disclosure.

In an exemplary embodiment of the present disclosure, there is also provided a computer-readable storage medium on which a program product capable of implementing the above-described method of the present specification is stored. In some possible implementations, various aspects of the present disclosure can also be implemented in the form of a program product, which includes program code, when the program product runs on a terminal device, the program code is used to cause the terminal device to execute the above-mentioned procedures in this specification. Steps according to various exemplary embodiments of the present disclosure are described in the “Example Methods” section.

A program product for implementing the above method according to some embodiments of the present disclosure may adopt a portable compact disc read only memory (CD-ROM) and include program codes, and may run on a terminal device, such as a personal computer. However, the program product of the present disclosure is not limited thereto, and in this document, a readable storage medium may be any tangible medium that contains or stores a program that can be used by or in conjunction with an instruction execution system, apparatus, or device.

A computer readable signal medium may include a propagated data signal in baseband or as part of a carrier wave with readable program code embodied thereon. Such propagated data signals may take a variety of forms, including but not limited to electromagnetic signals, optical signals, or any suitable combination of the foregoing. A readable signal medium can also be any readable medium, other than a readable storage medium, that can transmit, propagate, or transport the program for use by or in connection with the instruction execution system, apparatus, or device.

Program code embodied on a readable medium may be transmitted using any suitable medium, including but not limited to wireless, wireline, optical fiber cable, RF, etc., or any suitable combination of the foregoing.

Program code for performing the operations of the present disclosure may be written in any combination of one or more programming languages, including object-oriented programming languages—such as Java, C++, etc., as well as conventional procedural Programming Language—such as the “C” language or similar programming language. The program code may execute entirely on the user computing device, partly on the user device, as a stand-alone software package, partly on the user computing device and partly on a remote computing device, or entirely on the remote computing device or server execute on. In the case of a remote computing device, the remote computing device may be connected to the user computing device through any kind of network, including a local area network (LAN) or a wide area network (WAN), or may be connected to an external computing device (eg, using an Internet service provider business via an Internet connection).

It should be noted that although several modules or units of the apparatus for action performance are mentioned in the above detailed description, this division is not mandatory. Indeed, according to embodiments of the present disclosure, the features and functions of two or more modules or units described above may be embodied in one module or unit. Conversely, the features and functions of one module or unit described above may be further divided into multiple modules or units to be embodied.

Additionally, although the various steps of the methods of the present disclosure are depicted in the figures in a particular order, this does not require or imply that the steps must be performed in the particular order or that all illustrated steps must be performed to achieve the desired result. Additionally or alternatively, certain steps may be omitted, multiple steps may be combined into one step for execution, and/or one step may be decomposed into multiple steps for execution, and the like.

Those skilled in the art can easily understand from the description of the above embodiments that the exemplary embodiments described herein may be implemented by software, or by a combination of software and necessary hardware. Therefore, the technical solutions according to the embodiments of the present disclosure may be embodied in the form of software products, and the software products may be stored in a non-volatile storage medium (which may be CD-ROM, U disk, mobile hard disk, etc.) or on the network, which includes several instructions to cause a computing device (which may be a personal computer, a server, a mobile terminal, or a network device, etc.) to execute a method according to some embodiments of the present disclosure.

Other embodiments of the present disclosure will readily occur to those skilled in the art upon consideration of the specification and practice of the invention disclosed herein. This disclosure is intended to cover any variations, uses, or adaptations of this disclosure that follow the general principles of this disclosure and include common general knowledge or techniques in the technical field not disclosed by this disclosure. The specification and examples are to be regarded as exemplary only, with the true scope and spirit of the disclosure being indicated by the appended claims.

### INDUSTRIAL APPLICABILITY

The solution provided by the present disclosure improves the indexing and query efficiency of the to-be-queried region by constructing the spatial range index of the first trajectory, thereby improving the efficiency and accuracy of determining the trajectory adjacent to the trajectory to be queried in the to-be-queried region. Further, the to-be-queried region is pruned by region pruning, which simplifies the query range of the second trajectory, improves the efficiency of spatial range query, and speeds up the query process. Furthermore, by performing lower bound pruning process on the second trajectory, the calculation amount of the Frechet distance is reduced, and unnecessary trajectory query and query time are reduced. Finally, by randomly storing the spatial range index to the distributed server, the maintenance pressure of the trajectory data is reduced, and the reliability of the nearest neighbor trajectory query is improved.

1. A method for querying nearest neighbor trajectory, comprising:
acquiring a first trajectory to be queried, and determining spatial position information of the first trajectory;
generating a trajectory signature according to a positional relationship between the spatial position information of the first trajectory and a to-be-queried region;
determining a spatial position index code of the first trajectory by XZ-Ordering; and
constructing a spatial range index of the first trajectory according to the trajectory signature and the spatial position index code.

2. The method according to claim 1, further comprises:
determining an identification of the first trajectory; and
adding the identification of the first trajectory to a suffix of the spatial range index.

3. The method according to claim 2, further comprises:
obtaining a random number of the first trajectory;
adding the random number to a prefix of the spatial range index; and
storing the spatial range index randomly to a distributed server according to the prefix.

4. The method according to claim 1, further comprises:
taking out the to-be-queried region from a first priority queue storing to-be-queried regions;
determining a code length of the spatial position index code of the to-be-queried region; and
expanding the to-be-queried region or stopping splitting the to-be-queried region according to a size relationship between the code length and a preset length.

5. The method according to claim 4, wherein said stopping splitting the to-be-queried region according to the size relationship between the code length and the preset length comprises:
in response to the code length being greater than the preset length, stopping splitting the to-be-queried region; and
performing a spatial range query process in the to-be-queried region.

6. The method according to claim 4, wherein said expanding the to-be-queried region according to the size relationship between the code length and the preset length comprises:
in response to the code length being less than or equal to the preset length, generating a child node to-be-queried region of the to-be-queried region by performing recursive quad-tree splitting on the to-be-queried region, until a code length of the child node to-be-queried region is greater than or equal to the preset length.

7. The method according to claim 1, further comprises:
determining a second trajectory in the to-be-queried region, and storing the second trajectory in a second priority queue.

8. The method according to claim 1, further comprises:
determining a first Frechet distance between the first trajectory and the to-be-queried region;
in response to the first Fleischer distance being greater than or equal to a maximum distance threshold, performing a regional pruning process on the to-be-queried region; and
updating the maximum distance threshold according to a result of the region pruning process.

9. The method according to claim 1, further comprises:
determining a lower bound position of the first trajectory and a lower bound position of a second trajectory in the to-be-queried region;
performing a lower bound pruning process on the second trajectory of the to-be-queried region according to the lower bound position of the first trajectory and the lower bound position of the second trajectory,
the lower bound position comprises at least one of a lower bound position of a start point, a lower bound position of an end point and a lower bound position of a trajectory signature.

10. The method according to claim 9, wherein said performing the lower bound pruning process on the second trajectory of the to-be-queried region according to the lower bound position of the first trajectory and the lower bound position of the second trajectory comprises:
determining a Frechet distance of start points between the lower bound position of the start point of the first trajectory and the lower bound position of the start point of the second trajectory; and
performing a first lower bound pruning process on the second trajectory according to a size relationship between the Frechet distance of the start points and a first preset distance.

11. The method according to claim 9, wherein said performing lower bound pruning process on the second trajectory of the to-be-queried region according to the lower bound position of the first trajectory and the lower bound position of the second trajectory further comprises:
determining a Frechet distance of end points between the lower bound position of the end point of the first trajectory and the lower bound position of the end point of the second trajectory;
performing a second lower bound pruning process on the second trajectory according to a size relationship between the Frechet distance of the end points and a second preset distance.

12. The method according to claim 1, wherein said generating the trajectory signature according to the positional relationship between the spatial position information of the first trajectory and the to-be-queried region further comprises:
performing ordered coding on four child node to-be-queried regions of the to-be-queried regions;
marking a child node to-be-queried region which is passed by the first trajectory with a first identification, and marking a child node to-be-queried region which is not passed by the first trajectory with a second identification;
determining the trajectory signature of the first trajectory according to the ordered coding, the first identification and the second identification.

13. The method according to claim 12, wherein said performing the lower bound pruning process on the second trajectory of the to-be-queried region according to the lower bound position of the first trajectory and the lower bound position of the second trajectory further comprises:
determining a Frechet distance of trajectory signatures between a lower bound of the trajectory signature of the first trajectory and a lower bound of the trajectory signature of the second trajectory; and
performing a third lower bound pruning process on the second trajectory according to a size relationship between the Frechet distance of the trajectory signatures and a third preset distance.

14. (canceled)

15. An electronic device, comprising:
a processor; and
a memory for storing executable instructions for the processor;
wherein, the processor is configured to execute the following steps:
acquiring a first trajectory to be queried, and determining spatial position information of the first trajectory;
generating a trajectory signature according to a positional relationship between the spatial position information of the first trajectory and a to-be-queried region;
determining a spatial position index code of the first trajectory by XZ-Ordering; and
constructing a spatial range index of the first trajectory according to the trajectory signature and the spatial position index code.

16. A non-transitory computer-readable storage medium on which a computer program is stored, wherein when the computer program is executed by a processor, the following steps are implemented:
acquiring a first trajectory to be queried, and determining spatial position information of the first trajectory;
generating a trajectory signature according to a positional relationship between the spatial position information of the first trajectory and a to-be-queried region;
determining a spatial position index code of the first trajectory by XZ-Ordering; and
constructing a spatial range index of the first trajectory according to the trajectory signature and the spatial position index code.

17. The device according to claim 15, wherein the processor is configured to further execute the following steps:
determining an identification of the first trajectory; and
adding the identification of the first trajectory to a suffix of the spatial range index.

18. The device according to claim 17, wherein the processor is configured to further execute the following steps:
obtaining a random number of the first trajectory;
adding the random number to a prefix of the spatial range index; and
storing the spatial range index randomly to a distributed server according to the prefix.

19. The device according to claim 15, wherein the processor is configured to further execute the following steps:
taking out a to-be-queried region from a first priority queue storing to-be-queried regions;
determining a code length of the spatial position index code of the to-be-queried region; and
expanding the to-be-queried region or stopping splitting the to-be-queried region according to a size relationship between the code length and the preset length.

20. The device according to claim 19, wherein said expanding the to-be-queried region or stopping splitting the to-be-queried region according to the size relationship between the code length and the preset length comprises:
in response to the code length being greater than the preset length, not splitting the to-be-queried region;
performing a spatial range query process in the to-be-queried region.

21. The device according to claim 19, wherein said expanding the to-be-queried region or stopping splitting the to-be-queried region according to the size relationship between the code length and the preset length comprises:
in response to the code length being less than or equal to the preset length, generating a child node to-be-queried region of the to-be-queried region by performing recursive quad-tree splitting on the to-be-queried region, until a code length of the child node to-be-queried region is greater than or equal to the preset length.
